(19) United States
(12) Patent Application Publication
(10) Pub. No.: US 2025/0237149 A1
(43) Pub. Date: Jul. 24, 2025

(54) SEALING DEVICE FOR POWER GENERATING TURBINE

(71) Applicant: TURBO POWERTECH CO., LTD., Busan (KR)

(72) Inventors: Jae Hwa SON, Busan (KR); Gi Joo YANG, Busan (KR); Hoon JUNG, Busan (KR); Sam Sub BYUN, Busan (KR); Taek Ho CHUNG, Busan (KR)

(21) Appl. No.: 18/581,317

(22) Filed: Feb. 19, 2024

(30) Foreign Application Priority Data
Jan. 23, 2024 (KR) 10-2024-0014033

(51) Int. Cl. F01D 11/06; F01D 11/00; F01D 11/02

(52) U.S. Cl. CPC F01D 11/06; F01D 11/025; F01D 11/001; F05D 2300/10

(57) ABSTRACT

The present disclosure relates to a sealing device for a power generating turbine, which reduces an amount of a leaking fluid flowing between a rotary body and a stationary body of the power generating turbine, the sealing device including a base part coupled to the stationary body and having at least one or more protrusions extending therefrom toward the rotary body in such a way as to allow the free end portion thereof to be kept in no contact with the rotary body to reduce the amount of leaking fluid flowing.

### CROSS REFERENCE TO RELATED APPLICATION OF THE DISCLOSURE

The present application claims the benefit of Korean Patent Application No. 10-2024-0010284 filed in the Korean Intellectual Property Office on 01.23.2024, the entire contents of which are incorporated herein by reference.

### BACKGROUND

### Field

The present disclosure relates to a sealing device for a power generating turbine, more specifically to a sealing device for a power generating turbine that is capable of being provided with porous structures adapted to remarkably reduce the amount of a fluid leaking between a rotary body having a rotor and a stationary body having a casing in the power generating turbine.

### Description of the Related Art

Generally, a turbine is a machine that transforms rotational energy from a fluid such as water, gas, steam, and the like, into usable mechanical work.

That is, the turbine is a turbo type machine that transfers steam or gas to blades mounted on a rotary body to rotate the blades to a high speed. As industries have been developed, such a steam or gas turbine has increased in size and pressure.

The steam leaking sealing part mounted between the rotary body having a rotor and a stator of the turbine causes the power generation efficiency of the turbine to decrease, so that undesirably, a fuel cost increases, and accordingly, it is very important to design a sealing technology, that is, a sealing device for reducing a steam leak.

In detail, the sealing device is a device that is made of stainless steel used for a high pressure turbine using gas or steam and serves to prevent gas or steam from leaking from the turbine to improve the energy production of a generator to the maximum and prevent the rotor from being vibrated.

FIG. 1 is a sectional view showing a state where general sealing devices are mounted on a turbine.

As shown in FIG. 1, general sealing devices 5 are located on the external and internal rings of a diaphragm 3 mounted on a casing 2.

FIG. 2 is a sectional view showing a general labyrinth type sealing device.

As shown in FIG. 2, a labyrinth type sealing device 5 having sharp teeth 6 is widely used as an annular contactless sealing device for a turbine, and the labyrinth type sealing device 5 serves to reduce an amount of a leaking fluid using a throttling process of the fluid flowing in the turbine. To do this, the teeth 6 are sequentially arranged on a stator so that the amount of leaking fluid becomes reduced through the pressure drop generated in a process where the fluid is repeatedly throttled and expanded.

In the case where a space is sealed by means of the labyrinth type sealing device 5, however, a power generation efficiency loss occurring by the fluid leaking from the gap between a rotary body 1 and the labyrinth type sealing device 5 is greater than or equal to 33% of the total turbine efficiency loss.

In this case, the gap between the sealing device 5 and the rotary body 1 is narrow to thus decrease a steam leakage loss, but if the gap decreases due to the vibrations or thermal unbalance deformation of the rotary body 1 so that the sealing device 5 and the rotary body 1 come into contact with each other to cause rubbing therebetween, the teeth 6 of the sealing device 5 are abraded. As a result, as time passes, the sealing efficiency becomes deteriorated.

Relatively higher vibrations when the turbine starts to operate than those when the turbine normally operates are generated, and therefore, the gap between the rotary body 1 and the sealing device 5 has to have a given distance or more. However, if the gap between the rotary body 1 and the sealing device 5 is substantially large, an amount of leaking fluid increases, which reduces the sealing efficiency and causes the power generation efficiency loss of the turbine to increase.

To solve such problems, there is suggested a brush type sealing device that is provided with a brush made of wires having hair thicknesses and made from an alloy of nickel, chromium, tungsten, and molybdenum, but due to the high price of the brush and the complication in manufacturing process thereof, undesirably, the manufacturing cost of the brush type sealing device becomes very high.

### SUMMARY

Accordingly, the present disclosure has been made in view of the above-mentioned problems occurring in the related art, and it is an object of the present disclosure to provide a sealing device for a power generating turbine that is capable of more remarkably reducing an amount of a leaking fluid than a conventional sealing device for a turbine, thereby reducing a power generation efficiency loss of the turbine and greatly lowering a manufacturing cost thereof.

To accomplish the above-mentioned objects, according to the present disclosure, there is provided a sealing device for a power generating turbine, which reduces an amount of a leaking fluid flowing between a rotary body and a stationary body of the power generating turbine, the sealing device including a base part coupled to the stationary body and having at least one or more protrusions extending therefrom toward the rotary body in such a way as to allow the free end portion thereof to be kept in no contact with the rotary body to reduce the amount of leaking fluid flowing.

According to the present disclosure, desirably, the sealing device may further include at least one or more porous structures detachably coupled to the base part in such a way as to extend toward a direction crossing the flowing direction of the leaking fluid from the base part.

According to the present disclosure, desirably, the porous structures may have a plurality of pores irregularly formed thereon in such a way as to allow the leaking fluid to be introduced thereinto.

According to the present disclosure, desirably, the porous structures may be made of one or more metals selected from the group consisting of copper, nickel, aluminum, molybdenum, silver, platinum, gold, magnesium, tin, tungsten, cobalt, titanium, and iron.

According to the present disclosure, desirably, the porous structures may be located behind at least one or more of the protrusions.

According to the present disclosure, desirably, the sealing device may further include a support member for fixing the porous structures to the base part in such a way as to support any one or more positions selected from the front and rear sides of the porous structures thereagainst.

According to the present disclosure, desirably, the free end portion of the porous structures may protrude more downwardly than the free end portion of the support member.

According to the present disclosure, desirably, the free end portion of the porous structures may be kept spaced apart from the rotary body by a given distance.

According to the present disclosure, desirably, the free end portion of the porous structures may be brought into contact with the rotary body, and the porous structures may be made of a material that is deformable when an external force is applied thereto.

According to the present disclosure, desirably, the porous structures may be pressurizedly fixed to the support member and allow the porosity of the areas pressurized against the support member to be less than or equal to the porosity of the areas not pressurized against the support member.

According to the present disclosure, desirably, the support member may include a support body whose one end is fastened to the base part and free end portion extends toward the rotary body in such a way as to accommodate a portion of the porous structures therein, and the support body may have a tapered portion formed along the inner wall thereof in a downward direction where the free end of the support member is reduced in thickness.

According to the present disclosure, desirably, the support member may include a buffering space portion formed between the inner wall of the support body and the porous structures in such a way as to allow the porous structures to be deformable if an external force is applied to the porous structures.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a sectional view showing a state where general sealing devices are mounted on a turbine;

FIG. 2 is a sectional view showing a general labyrinth type sealing device;

FIG. 3 is a sectional view showing a state where a sealing device for a power generating turbine according to an embodiment of the present disclosure is mounted on the power generating turbine;

FIG. 4 is a perspective view showing the sealing device for the power generating turbine according to the present disclosure;

FIG. 5 is an enlarged view showing a portion A of FIG. 4 seen on top thereof;

FIG. 6 is an enlarged view showing the portion A of FIG. 4 seen on bottom thereof;

FIG. 7 is a sectional view showing the sealing device for the power generating turbine according to the embodiment of the present disclosure;

FIG. 8 is a sectional view showing a sealing device for a power generating turbine according to another embodiment of the present disclosure;

FIG. 9 is a sectional view showing a state where porous structures and a support member of a sealing device for a power generating turbine according to a first additional embodiment of the present disclosure are coupled to each other;

FIG. 10 is a sectional view showing a state where porous structures and a support member of a sealing device for a power generating turbine according to a second additional embodiment of the present disclosure are coupled to each other;

FIG. 11 is a sectional view showing a state where porous structures and a support member of a sealing device for a power generating turbine according to a third additional embodiment of the present disclosure are coupled to each other;

FIG. 12 is a sectional view showing a state where porous structures and a support member of a sealing device for a power generating turbine according to another example of the third additional embodiment of the present disclosure are coupled to each other;

FIG. 13 is a sectional view showing a state where porous structures and a support member of a sealing device for a power generating turbine according to a fourth additional embodiment of the present disclosure are coupled to each other; and

FIG. 14 is a sectional view showing a state where porous structures and a support member of a sealing device for a power generating turbine according to another example of the fourth additional embodiment of the present disclosure are coupled to each other.

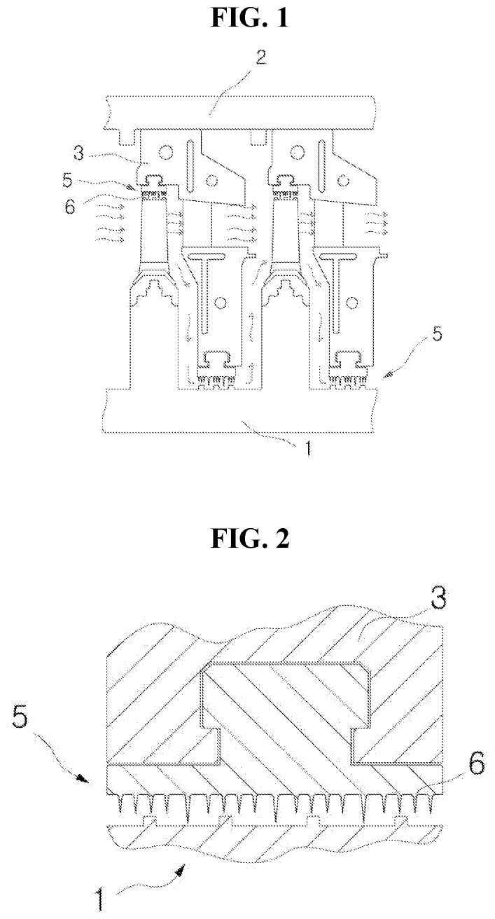

### DETAILED DESCRIPTION OF THE PREFERRED EMBODIMENT

Objects, characteristics and advantages of the present inventive concept will be more clearly understood from the detailed description as will be described below and the attached drawings.

Before the present inventive concept is disclosed and described, it is to be understood that the disclosed embodiments are merely exemplary of the inventive concept, which can be embodied in various forms. Therefore, specific structural and functional details disclosed herein are not to be interpreted as limiting, but merely as a basis for the claims and as a representative basis for teaching one of ordinary skill in the art to variously employ the present inventive concept in virtually any appropriately detailed structure.

Terms used in this application are used to only describe specific exemplary embodiments and are not intended to restrict the present disclosure.

An expression referencing a singular value additionally refers to a corresponding expression of the plural number, unless explicitly limited otherwise by the context. In the description, when it is said that one portion is described as “includes” any component, one element further may include other components unless no specific description is suggested.

All terms used herein, including technical or scientific terms, unless otherwise defined, have the same meanings which are typically understood by those having ordinary skill in the art.

Hereinafter, an explanation of a sealing device for a power generating turbine according to the present disclosure will be given in detail with reference to the attached drawings.

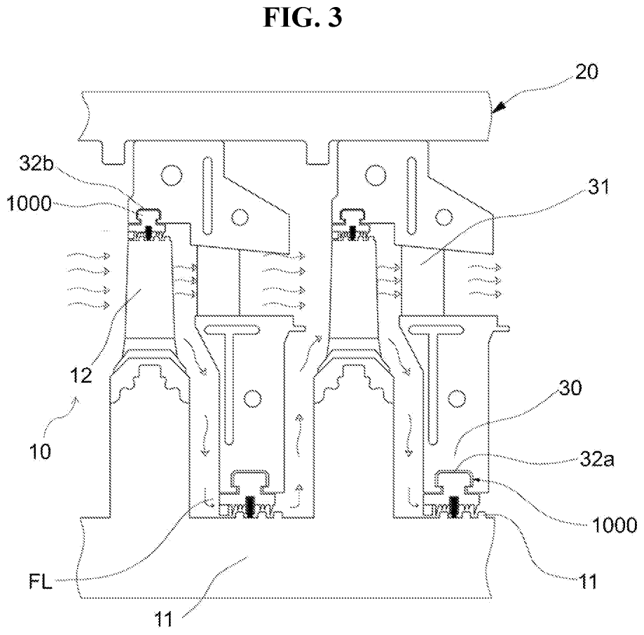

FIG. 3 is a sectional view showing a state where a sealing device for a power generating turbine according to an embodiment of the present disclosure is mounted on the power generating turbine.

As shown in FIG. 3, a power generating turbine includes a rotary body 10 having a rotor 11 and blades 12, a stationary body 20 having a casing, and diaphragms 30 fastened to the stationary body 20 in such a way as to extend toward the blades 12 and the rotor 11.

In this case, each diaphragm 30 is coupled to a sealing device 1000 for a power generating turbine according to the present disclosure and includes a first coupling portion 32a formed at a position close to a shaft of the rotor 11 and a second coupling portion 32b formed at a position close to the corresponding blade 12.

However, the mounted positions of the sealing devices 1000 according to the present disclosure may not be limited thereto, and accordingly, it can be understood that the sealing devices 1000 according to the present disclosure may be mounted on all places between the rotary body 10 and the stationary body 20 where sealing is needed. In detail, the sealing devices 1000 according to the present disclosure are mounted on moving paths of leaking fluids (FL) not passing through the blades 12, thereby reducing amounts of leaking fluids (FL) flowing.

As shown by the arrows of FIG. 3, most of steam or gas introduced into the stationary body 20 passes through a partition 31 of the fixed diaphragm 30, rotates the blade 12 extending from the side periphery of the rotor 11, is induced by the neighboring partition to rotate the next blade 12, and is finally discharged to the outside.

If the blades 12 rotate, through such a process, the rotary body 10 having the blades 12 rotates to perform power generation.

In this case, desirably, the diaphragm 30 has the first coupling portion 32a and the second coupling portion 32b formed on the periphery thereof in such a way as to allow the sealing devices 1000 to be fixedly mounted thereon, and further, the sealing devices 1000 have stepped projections protruding from the outer peripheries thereof in such a way as to have the corresponding shapes to the coupling portions of the diaphragm 30, so that the stepped projections are fixedly fitted to the coupling portions.

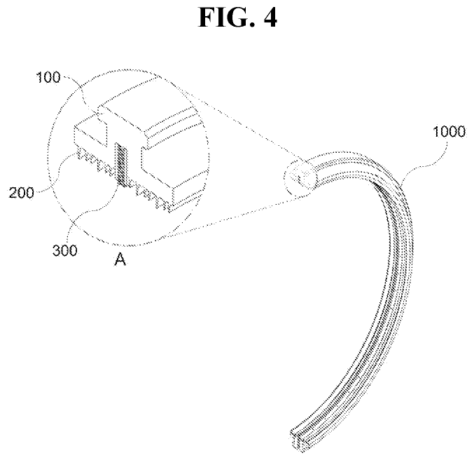

Next, the sealing device for the power generating turbine according to an embodiment of the present disclosure will be explained in detail with reference to FIGS. 4 to 7.

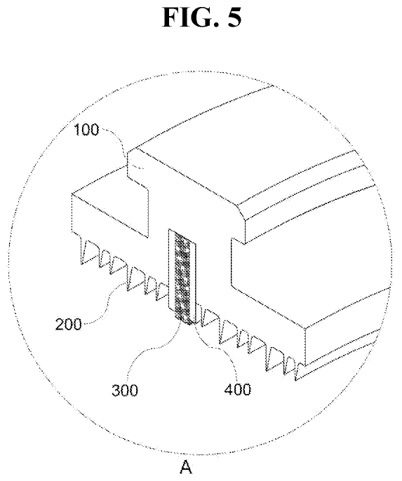

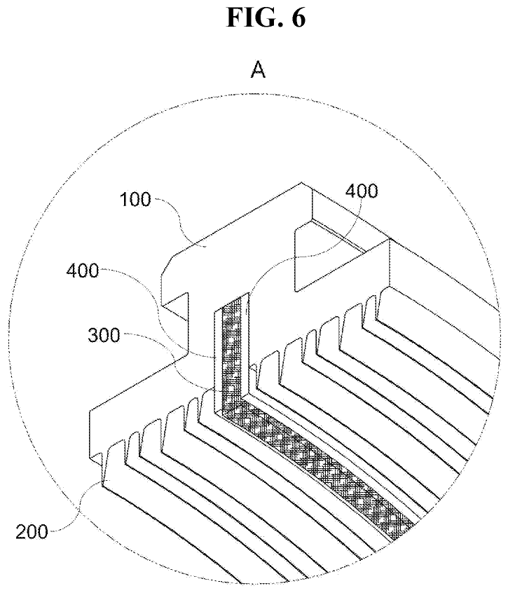

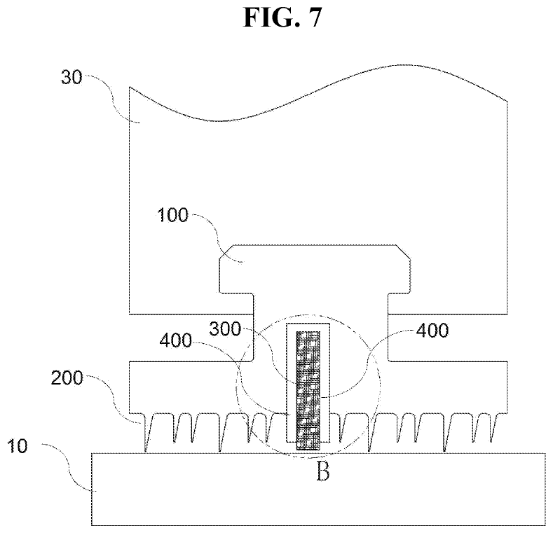

FIG. 4 is a perspective view showing the sealing device for the power generating turbine according to the present disclosure, FIG. 5 is an enlarged view showing a portion A of FIG. 4 seen on top thereof, FIG. 6 is an enlarged view showing the portion A of FIG. 4 seen on bottom thereof, and FIG. 7 is a sectional view showing the sealing device for the power generating turbine according to the embodiment of the present disclosure.

First, the sealing device 1000 for the power generating turbine according to the present disclosure is configured to reduce an amount of a leaking fluid flowing between the rotary body and the stationary body of the power generating turbine.

In detail, the sealing device 1000 includes a base part 100, protrusions 200, and porous structures 300.

First, the base part 100 is coupled to the stationary body to the shape of a ring and has a stepped projection with a given shape protruding from top thereof in such a way as to be fastened to the stationary body.

In this case, the base part 100 is divided into a plurality of parts so that it can be smoothly fastened to the stationary body, and when the plurality of divided base parts are fastened to the stationary body, the fastened base part 100 has the shape of the ring.

Further, the protrusions 200 protrude from the base part 100 and serve to reduce the amount of leaking fluid flowing. In detail, the protrusions 200 extend from the base part 100 toward the rotary body when the base part 100 is fastened to the stationary body.

In this case, the free ends of the protrusions 200 are kept in no contact with the rotary body.

Through the protrusions 200 for reducing the amount of leaking fluid flowing in such a way as to have no direct contact with the rotary body, the flowing path of the fluid is varied so that the amount of leaking fluid is reduced, while no interference is occurring in the rotation of the rotary body.

In this case, the protrusions 200 are machined together with the base part 100, and otherwise, of course, they may be additionally machined after the base part 100 has been machined and then fastened to the base part 100.

Next, the porous structures 300 serve to distribute the moving path of the leaking fluid to reduce the amount of leaking fluid and are made of a metal. In detail, the porous structures 300 are constituted of metal foams with a plurality of pores.

The metal foam represents a foam made of a metal and having irregular pores formed therein, and desirably, the metal foam does not react with a fluid when it comes into contact with the fluid introduced thereinto and has given corrosion resistance and durability.

The metal foam is made by making a metal to a thin steel wire, entangling the steel wire irregularly, and forming pores, and through the structural compensation of the pores, the entire metal foam has appropriate ductility and elasticity.

Moreover, the porous structures 300 according to the present disclosure include at least one or more types of metals as main ingredients thereof.

In this case, the metals as the main ingredients of the porous structures 300 are present in an amount of greater than or equal to 55% by weight, in an amount of greater than or equal to 60% by weight, in an amount of greater than or equal to 65% by weight, in an amount of greater than or equal to 70% by weight, in an amount of greater than or equal to 75% by weight, in an amount of greater than or equal to 80% by weight, in an amount of greater than or equal to 85% by weight, in an amount of greater than or equal to 90% by weight, or in an amount of greater than or equal to 95% by weight, per the total weight of the metal foam or the metal structure. The limit of the amount of metals contained as the main ingredients may not be limited thereby, and for example, the metals may be present in an amount of 100% by weight.

Further, the porous structures 300 are made of one or more metals selected from the group consisting of copper, nickel, aluminum, molybdenum, silver, platinum, gold, magnesium, tin, tungsten, cobalt, titanium, and iron.

Furthermore, the porous structures 300 are made of an alloy having one or more metals selected from the group consisting of copper, nickel, aluminum, molybdenum, silver, platinum, gold, magnesium, tin, tungsten, cobalt, titanium, and iron, and accordingly, the porous structures 300 are not damaged or deformed even in a high temperature and high pressure environment of the power generating turbine operating, thereby ensuring high operational reliability.

In this case, the porous structures 300 have a plurality of irregular pores into which the leaking fluid is introduced.

Through the plurality of irregular pores, in detail, the moving path of the leaking fluid is distributed, and the flowing speed of the leaking fluid remarkably decreases, so that the amount of leaking fluid during the same time is reduced, thereby improving the power generation efficiency of the power generating turbine.

Further, the porous structures 300 have the porosity of 10 to 90%, and if the porosity is less than 10%, the durability of the porous structures 300 becomes bad. Contrarily, if the porosity is over 90%, a flowing resistance to the leaking fluid through the porous structures 300 do not increase to an extent of reducing the amount of leaking liquid, and therefore, the porosity is set to satisfy the above-mentioned range.

In addition, all types of scales having fine particle sizes, which are produced during the operation of the power generating turbine, are collected into the pores formed on the porous structures 300.

In this case, as the use time of the porous structures 300 increases, the porosity of the porous structures 300 becomes lowered due to the consistent collection of the scales into the pores of the porous structures 300.

That is, the flowing resistance to the leaking fluid increases due to the reduction of the porosity of the porous structures 300 caused by the accumulated use time of the porous structures 300.

While the power generating turbine is operating, further, foreign substances generated inside the casing scatter by means of the high pressure fluid to cause various types of parts of the power generating turbine to be damaged, and in this case, the foreign substances are collected and filtered through the porous structures 300, so that their scattering is minimized to decrease the damages of the parts of the power generating turbine.

Further, at least one or more of the porous structures 300 are fastened to the base part 100.

In this case, the porous structures 300 are fastened to the base part 100 by means of fitting, and to do this, an accommodation groove for accommodating the porous structures 300 is formed on the base part 100.

Further, the porous structures 300 are detachably coupled to the base part 100 and extend toward a direction crossing the flowing direction of the leaking fluid from the base part 100.

Further, the porous structures 300 extend in the same direction as the extending directions of the protrusions 200 and thus limit the flow of the leaking fluid.

Further, the porous structures 300 are located behind at least one or more of the protrusions 200.

In detail, the porous structures 300 are located behind any one or more protrusions 200.

As a result, the porous structures 300 are not first exposed to the high temperature and high pressure gas, thereby being prevented from being varied in position or deformed in shape due to the gas.

Further, the free end portion of the porous structures 300 is kept spaced apart from the rotary body by a given distance.

As a result, the friction between the porous structures 300 and the rotary body is avoided, thereby extending the lifetime of the porous structures 300.

Even though not shown specially in the drawings, further, the porous structures 300 are made to the form of sheets or blocks, and in this case, the sheets or blocks are laid on top of one another and thus fastened to the base 300.

In detail, at least one or more porous structures 300 are pressurized and then fastened to the base part 100, and of course, the plurality of pressurized porous structures 300 laid on top of one another may be fastened to the base part 100.

In this case, the porous structures 300 are pressurized in thickness directions thereof, but of course, the pressurized directions thereof may not be limited thereto.

Like this, the plurality of porous structures 300 are laid on top of one another, and otherwise, the porous structures 300 are pressurized, so that the porosity of the porous structures 300 decreases to improve fluid blocking performance.

Further, the sealing device for the power generating turbine according to the embodiment of the present disclosure includes a support member 400.

In detail, the support member 400 serves to fix the porous structures 300 to the base part 100.

In this case, the support member 400 supports any one or more positions selected from the front and rear sides of the porous structures 300 thereagainst.

Through the formation of the support member 400, that is, the porous structures 300 are kept in shape and fixed to the base part 100 more firmly, thereby ensuring high durability and operational reliability.

When the porous structures 300 are coupled to the support member 400, further, the free end portion of the porous structures 300 protrudes more downwardly than the free end portion of the support member 400.

In detail, as the free end portion of the porous structures 300 protrudes more downwardly than the free end portion of the support member 400, the contact between the support member 400 and the rotary body 10 is minimized.

Further, the damage of the support member 400 and the position escape of the porous structures 300, which occur upon the contact between the support member 400 and the rotary body 10, are prevented, thereby ensuring high reliability.

Further, the porous structures 300 are pressurized against the support member 400 and thus fixed in position.

In this case, the porous structures 300 allow the porosity of regions pressurized against the support member 400 to be less than or equal to the porosity of regions not pressurized against the support member 400.

In detail, the porous structures 300 are designed to allow the porosity of the portions pressurizedly fixed to the support member 400 to decrease, so that because of the low porosity, the fluid blocking performance is improved.

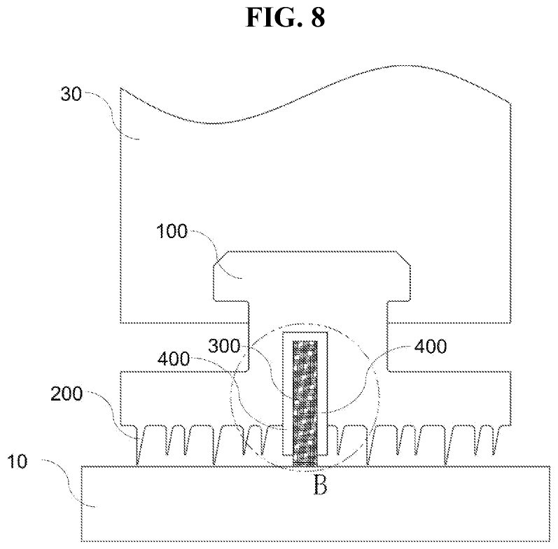

Next, a sealing device for a power generating turbine according to another embodiment of the present disclosure will be explained in detail with reference to FIG. 8.

FIG. 8 is a sectional view showing a sealing device for a power generating turbine according to another embodiment of the present disclosure.

As shown in FIG. 8, the free end portion of the porous structures 300 is brought into contact with the rotary body 10.

In this case, the porous structures 300 are made of a material with given ductility so that they can be deformable when an external force is applied thereto.

As mentioned above, the porous structures 300 are brought into contact with the rotary body 10, thereby ensuring good fluid blocking performance, and further, the porous structures 300 are deformable so that they can be prevented from being damaged and broken due to the contact with the rotary body 10.

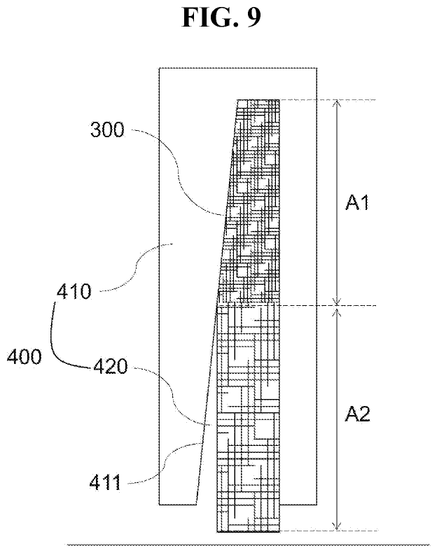

Next, a sealing device for a power generating turbine according to additional embodiments of the present disclosure will be explained in detail with reference to FIGS. 9 to 12.

FIG. 9 is a sectional view showing a state where porous structures and a support member of a sealing device for a power generating turbine according to a first additional embodiment of the present disclosure are coupled to each other.

In this case, the support member 400 includes a support body 410 and a buffering space portion 420.

First, one end of the support body 410 is fastened to the base part 100, and the free end portion of the support body 410 extends toward the rotary body 10, while accommodating a portion of the porous structures 300 thereinto.

In this case, the support body 410 has a tapered portion 411 formed along the inner wall thereof in a downward direction where the free end of the support member 400 is reduced in thickness.

Through the formation of the tapered portion 411, as a result, a region where the porosity gradually decreases becomes expanded, thereby ensuring good fluid blocking performance.

In this case, the porous structures 300 have a first region A1 where one surface thereof to which an external force is not applied comes into contact with the tapered portion 411 and a second region A2 where one surface thereof is spaced apart from the tapered portion 411 by a given distance.

In this case, the porosity of the first region A1 is less than or equal to that of the second region A2, and the porous structures 300 are coupled to the support member 400 in such a way as to allow the porosity to be gradually reduced from the second area A2 towards the first area A1.

Further, the buffering space portion 420 is formed between the inner wall of the support body 410 and the porous structures 300 so that if an external force is applied to the porous structures 300, the porous structures 300 are deformable.

In this case, the support body 410 is closed on top thereof and open on the bottom thereof, and as shown in FIG. 9, the support body 410 has the tapered portion 411 and the buffering space portion 420 formed on one selected from the pair of free ends facing each other.

In detail, if an impact generated from the contact between the porous structures 300 and the rotary body 10 is applied to the porous structures 300, a given space in which the porous structures 300 are deformed to absorb the impact is ensured by means of the buffering space portion 420, thereby minimizing the damage of the power generating turbine.

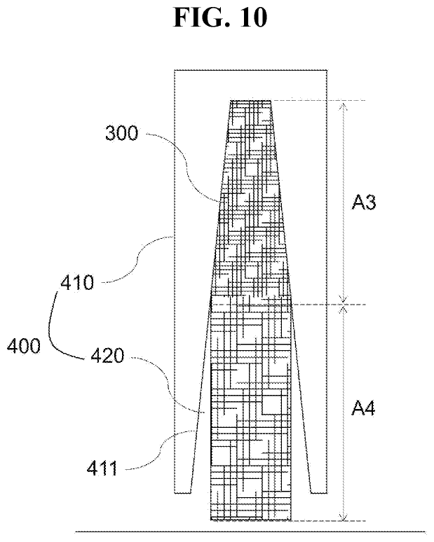

Next, a sealing device for a power generating turbine according to a second additional embodiment of the present disclosure will be explained in detail with reference to FIG. 10.

FIG. 10 is a sectional view showing a state where porous structures and a support member of a sealing device for a power generating turbine according to a second additional embodiment of the present disclosure are coupled to each other.

As shown in FIG. 10, a support body 410 is closed on top thereof and open on the bottom thereof, and the support body 410 has tapered portions 411 and buffering space portions 420 formed on both sides of a pair of free ends facing each other.

In this case, the porous structures 300 have a third region A3 where both side surfaces thereof to which an external force is not applied come into contact with the tapered portions 411 and a fourth region A4 where both side surfaces thereof are spaced apart from the tapered portions 411 by a given distance.

In this case, the porosity of the third region A3 is less than or equal to that of the fourth region A4, and the porous structures 300 are coupled to the support member 400 in such a way as to allow the porosity to be gradually reduced from the fourth area A4 towards the third area A3.

As a result, as the buffering space portions 420 are formed on both sides of the porous structures 300, the porous structures 300 are more flexibly deformable, so that even if an impact is applied to the porous structures 300 from the rotary body 10, the porous structures 300 as well as the rotary body 10 are prevented from being damaged.

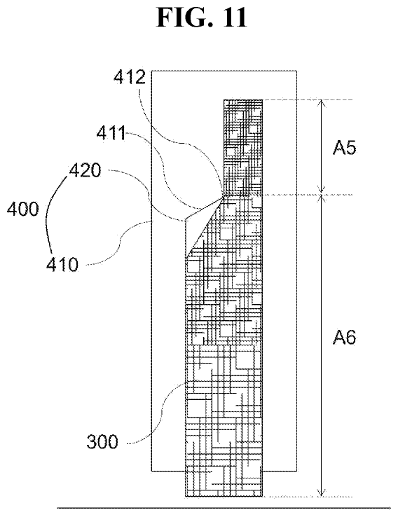

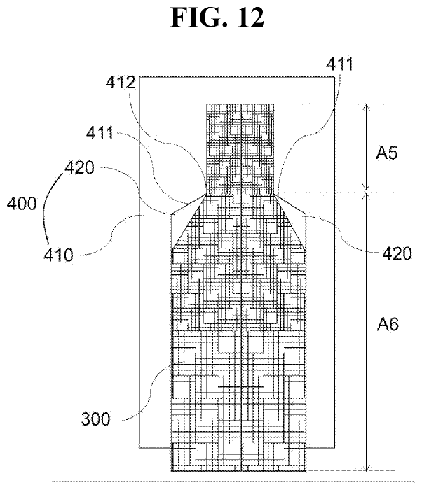

Next, a sealing device for a power generating turbine according to a third additional embodiment of the present disclosure will be explained with reference to FIGS. 11 and 12.

FIG. 11 is a sectional view showing a state where a porous structure and a support member of a sealing device for a power generating turbine according to a third additional embodiment of the present disclosure are coupled to each other, and FIG. 12 is a sectional view showing a state where a porous structure and a support member of a sealing device for a power generating turbine according to another example of the third additional embodiment of the present disclosure are coupled to each other.

As shown in FIG. 11, a support body 410 is closed on top thereof and open on the bottom thereof, and the support body 410 has a tapered portion 411 and a buffering space portion 420 formed on one side of a pair of free ends facing each other.

In this case, the support body 410 has at least one bent point 412 formed between top and bottom of the inner wall thereof, and the tapered portion 411 extend from the bent point 412.

In this case, the porous structures 300 have a fifth region A5 where one side surfaces thereof to which an external force is not applied comes into contact with the tapered portion 411 and a sixth region A6 from points where the bent point 412 starts to the bottom thereof.

In this case, the porosity of the fifth region A5 is less than or equal to that of the sixth region A6, and the porous structures 300 are coupled to the support member 400 in such a way as to allow the porosity to be gradually reduced from the sixth area A6 towards the fifth area A5.

In detail, as at least one bent point 412 is formed, the pressurization of the support body 410 on the area above the bent point 412 against the porous structures 300 becomes strong, thereby improving the coupling force between the porous structures 300 and the support member 400, and as the accommodation space of the support body 410 on the area under the bent point 412 is expanded, a large amount of leaking fluid is introduced into the porous structures 300, thereby improving the fluid blocking performance.

Further, as shown in FIG. 12, as tapered portions 411, bent points 412, and buffering space portions 420 are formed on both side inner walls of the support body 410 around the porous structures 300, the area of the porous structures 300 become more expanded.

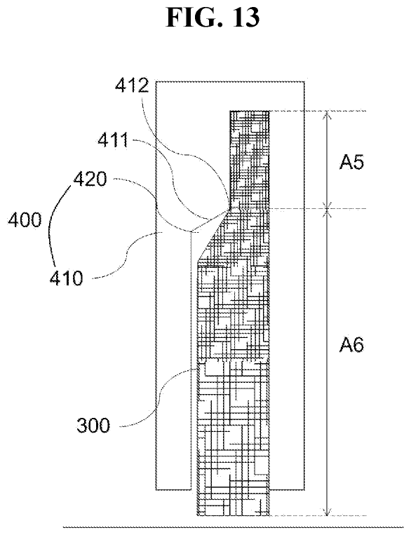

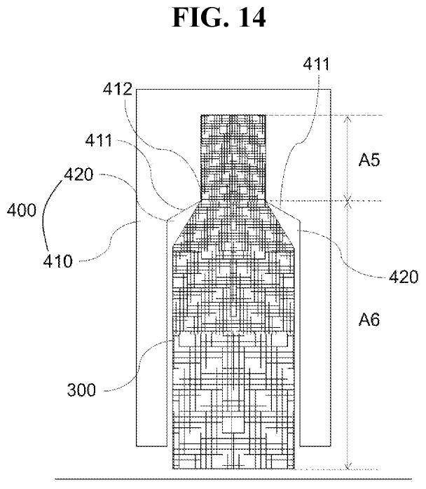

Next, a sealing device for a power generating turbine according to a fourth additional embodiment of the present disclosure will be explained in detail with reference to FIGS. 13 and 14.

FIG. 13 is a sectional view showing a state where porous structures and a support member of a sealing device for a power generating turbine according to a fourth additional embodiment of the present disclosure are coupled to each other, and FIG. 14 is a sectional view showing a state where porous structures and a support member of a sealing device for a power generating turbine according to another example of the fourth additional embodiment of the present disclosure are coupled to each other.

In the same manner as the sealing device for a power generating turbine according to the third additional embodiment of the present disclosure, a sealing device for a power generating turbine according to a fourth additional embodiment of the present disclosure is configured to have at least one or more bent points 412 formed on a support body 410.

In detail, as shown in FIG. 13, the sealing device for a power generating turbine according to the fourth additional embodiment of the present disclosure allows a buffering space portion 420 to be expanded, and in this case, the buffering space portion 420 is formed between the inner wall of the support body 410 and the porous structures 300 so that if an external force is applied to the porous structures 300, the porous structures 300 become deformable.

Further, as shown in FIG. 14, as bent points 412, tapered portions 411, and buffering space portions 420 are formed on both side inner walls of the support body 410 around the porous structures 300, the area of the porous structures 300 become more expanded.

As described above, the sealing device for the power generating turbine according to the present disclosure is configured to allow the flowing path of the fluid to be varied by means of the protrusions for reducing the amount of leaking fluid flowing in such a way as to have no direct contact with the rotary body, so that the amount of leaking fluid is reduced, while no interference is occurring in the rotation of the rotary body, thereby improving the power generation efficiency of the power generating turbine.

Further, the sealing device for the power generating turbine according to the present disclosure is configured to allow the flowing path of the fluid to be distributed by means of the porous structures, so that the amount of fluid leaking is reduced, thereby improving the power generation efficiency of the power generating turbine.

Furthermore, the sealing device for the power generating turbine according to the present disclosure is configured to allow the flowing path of the leaking fluid to be distributed and allow the flowing speed of the leaking fluid to remarkably decrease by means of the plurality of irregular pores formed on the porous structures, so that the amount of leaking fluid during the same time is reduced, thereby improving the power generation efficiency of the power generating turbine.

Moreover, the sealing device for the power generating turbine according to the present disclosure is configured to allow the porous structures to be made of an alloy having one or more metals selected from the group consisting of copper, nickel, aluminum, molybdenum, silver, platinum, gold, magnesium, tin, tungsten, cobalt, titanium, and iron, so that the porous structures are not damaged or deformed even in a high temperature and high pressure environment of the power generating turbine operating, thereby ensuring high operational reliability.

Besides, the device for sealing the power generating turbine according to the present disclosure is configured to allow the porous structures to be located behind one or more protrusions, so that the porous structures are not first exposed to the high temperature and high pressure gas, thereby being prevented from being varied in position or deformed in shape due to the gas.

In addition, the sealing device for the power generating turbine according to the present disclosure is configured to allow the porous structures to be kept in shape and fixed to the base part more firmly by means of the support member, thereby ensuring high durability and operational reliability.

Further, the sealing device for the power generating turbine according to the present disclosure is configured to allow the free end portion of the porous structures to protrude more downwardly than the free end portion of the support member, so that the contact between the support member and the rotary body is minimized and the damage of the support member and the position escape of the porous structures, which occur upon the contact between the support member and the rotary body, are prevented, thereby ensuring high reliability.

Moreover, the sealing device for the power generating turbine according to the present disclosure is configured to allow the free end portion of the porous structures to be kept spaced apart from the rotary body by a given distance, so that the friction between the porous structures and the rotary body is avoided, thereby extending the lifetime of the porous structures.

Furthermore, the sealing device for the power generating turbine according to the present disclosure is configured to allow the porous structures to be brought into contact with the rotary body, thereby ensuring good fluid blocking performance, and configured to allow the porous structures to be deformable, so that the porous structures are prevented from being damaged and broken due to the contact with the rotary body.

In addition, the sealing device for the power generating turbine according to the present disclosure is configured to allow the porosity of the portions pressurizedly fixed to the support member to decrease, so that because of the low porosity, the fluid blocking performance is improved.

Further, the device sealing for the power generating turbine according to the additional embodiment of the present disclosure is configured to allow an area where porosity becomes gradually reduced to be expanded through the tapered portion of the support member, thereby improving the fluid blocking performance.

Furthermore, the sealing device for the power generating turbine according to the additional embodiment of the present disclosure is configured to allow a given space in which the porous structures are deformed to absorb an impact to be ensured by means of the buffering space portion, if the impact generated from the contact between the porous structures and the rotary body is applied to the porous structures, thereby minimizing the damage of the power generating turbine.

While the present inventive concept has been described with reference to the particular illustrative embodiments, it is not to be restricted by the embodiments but only by the appended claims. It is to be appreciated that those skilled in the art can change or modify the embodiments without departing from the scope and spirit of the present inventive concept.

1. A sealing device for a power generating turbine, which reduces an amount of a leaking fluid flowing between a rotary body and a stationary body of the power generating turbine, the sealing device comprising a base part (100) coupled to the stationary body and having at least one or more protrusions (200) extending therefrom toward the rotary body in such a way as to allow the free end portion thereof to be kept in no contact with the rotary body to reduce the amount of leaking fluid flowing.

2. The sealing device according to claim 1, further comprising at least one or more porous structures (300) detachably coupled to the base part (100) in such a way as to extend toward a direction crossing the flowing direction of the leaking fluid from the base part.

3. The sealing device according to claim 2, wherein the porous structures (300) have a plurality of pores irregularly formed thereon in such a way as to allow the leaking fluid to be introduced thereinto.

4. The sealing device according to claim 2, wherein the porous structures (300) are made of one or more metals selected from the group consisting of copper, nickel, aluminum, molybdenum, silver, platinum, gold, magnesium, tin, tungsten, cobalt, titanium, and iron.

5. The sealing device according to claim 2, wherein the porous structures (300) are located behind at least one or more of the protrusions (200).

6. The sealing device according to claim 2, further comprising a support member (400) for fixing the porous structures (300) to the base part (100) in such a way as to support any one or more positions selected from the front and rear sides of the porous structures (300) thereagainst.

7. The sealing device according to claim 6, wherein the free end portion of the porous structures (300) protrudes more downwardly than the free end portion of the support member (400).

8. The sealing device according to claim 2, wherein the free end portion of the porous structures (300) is kept spaced apart from the rotary body by a given distance.

9. The sealing device according to claim 2, wherein the free end portion of the porous structures (300) is brought into contact with the rotary body 10, and the porous structures (300) are made of a material that is deformable when an external force is applied thereto.

10. The sealing device according to claim 6, wherein the porous structures (300) are pressurizedly fixed to the support member and allow the porosity of the areas pressurized against the support member (400) to be less than or equal to the porosity of the areas not pressurized against the support member (400).

11. The sealing device according to claim 6, wherein the support member (400) comprises a support body (410) whose one end is fastened to the base part (100) and free end portion extends toward the rotary body in such a way as to accommodate a portion of the porous structures (300) therein, and the support body (410) has a tapered portion (411) formed along the inner wall thereof in a downward direction where the free end of the support member (400) is reduced in thickness.

12. The sealing device according to claim 11, wherein the support member (400) comprises a buffering space portion (420) formed between the inner wall of the support body (410) and the porous structures (300) in such a way as to allow the porous structures (300) to be deformable if an external force is applied to the porous structures (300).
